(19) United States
(12) Patent Application Publication
(10) Pub. No.: US 2026/0168176 A1
(43) Pub. Date: Jun. 18, 2026

(54) THERMAL BARRIER COATING FOR NON-TOP-COATED (NTC) PAPER

(71) Applicant: Iconex LLC, Duluth, GA (US)

(72) Inventor: Dong Keun Kim, Morristown, TN (US)

(21) Appl. No.: 19/356,867

(22) Filed: Oct. 13, 2025

Related U.S. Application Data
(60) Provisional application No. 63/707,308, filed on Oct. 15, 2024.

(51) Int. Cl. D21H 19/82; C09D 5/02; C09D 5/26; C09D 133/04; C09J 7/29; D21H 19/12

(52) U.S. Cl. CPC D21H 19/824; C09D 5/022; C09D 5/26; C09D 133/04; C09J 7/29; D21H 19/12; C09J 2203/334; C09J 2400/283; C09J 2433/006

(57) ABSTRACT

A novel barrier coating for non-top-coated (NTC) phenol-free direct thermal paper enhances humidity resistance while maintaining cost-effectiveness and environmental sustainability. The coating atop the thermal-sensitive layer protects against moisture and high heat conditions, preserving image quality and density. Comprising a specific formulation of hard and soft film-forming acrylic emulsions, the barrier coating melts during printing, ensuring non-interference with thermal image formation. This innovation addresses limitations of traditional top-coated papers, offering improved performance without increased costs or environmental impact. The coating process involves precise application and drying techniques, resulting in a product that balances humidity resistance, print quality, and eco-friendliness for various applications, including labeling, ticketing, and receipt printing.

### RELATED APPLICATIONS

The present application is a non-provisional patent application of U.S. Provisional Application No. 63/707,308 filed on Oct. 15, 2024, entitled “Thermal Barrier Coating for Non-Top Coated (NTC) Paper,” the disclosure of which is incorporated by reference herein in its entirety.

### BACKGROUND

Thermal printing technology has become widely adopted for various applications such as labeling, ticketing, and receipt printing due to its simplicity and cost-effectiveness. However, thermal papers face significant challenges when exposed to environmental conditions, particularly moisture and humidity, which can adversely affect print image quality. To address this issue, some manufacturers have developed top-coated thermal papers that provide better protection against humidity and improve image density. Nevertheless, these top-coated papers come with their own set of drawbacks. They are more expensive than non-top-coated papers, which increases the overall cost of printing and makes them less attractive for applications where cost is a significant factor. Additionally, the topcoat can sometimes interfere with the thermal image reaction, potentially reducing print quality. Furthermore, top-coated papers are less environmentally friendly than non-top-coated papers, as the additional coating layer can contribute to waste and pollution. These limitations highlight the need for innovative solutions that can enhance the performance of thermal papers while addressing cost, quality, and environmental concerns.

### BRIEF DESCRIPTION OF THE DRAWINGS

FIG. 1 is a diagram of a barrier coating applied to a non-top-coated (NTC) thermal paper, according to an example embodiment.

FIG. 2 is a diagram of a method for making and applying the barrier coating to an NTC thermal paper, according to an example embodiment.

### DETAILED DESCRIPTION

As used herein, the discussed embodiments and the embodiments below address several key problems in the field of thermal paper and label printing. The embodiments provided solve issues associated with the high manufacturing costs of top-coated thermal papers while improving humidity resistance for non-top-coated (NTC) phenol-free direct thermal papers.

While effective in resisting humidity, traditional top-coated papers are more expensive and less environmentally friendly. The embodiments provide a cost-effective and eco-friendly alternative by applying a barrier coating to NTC phenol-free direct thermal paper. The barrier coating enhances humidity resistance and prevents interference with the thermal image reaction during printing. NTC phenol-free thermal papers tend to show weaker moisture and humidity resistance than phenol-based thermal papers, decreasing image density and quality in severe high-heat and humidity environments. Embodiments herein provide a barrier coating on the non-top-coated surface of the paper to maintain maximum image density in such conditions by providing a consistent film-forming layer on the top of the thermal layer.

Additionally, embodiments herein address the environmental concerns related to NTC papers by allowing more sustainable NTC papers to be used. The embodiments thus offer a solution that balances cost-effectiveness, print quality, humidity resistance, and environmental considerations in thermal paper technology.

Thermal printing is a digital printing process that produces a printed image by selectively heating coated thermochromic or thermal paper. The coating layer on the thermal paper reacts to the heat and changes color, creating an image. This technology is widely used in various applications such as labeling, ticketing, and receipt printing due to its simplicity and cost-effectiveness. However, thermal papers are sensitive to environmental conditions, particularly moisture and humidity, which can affect their print image quality.

Some manufacturers have developed top-coated thermal papers to address the moisture sensitivity of thermal papers. These papers have an additional coating layer on the surface that provides better protection against humidity and improves the image density and quality. However, top-coated papers are more expensive than non-top-coated papers, which increases the overall cost of printing.

Despite the effectiveness of top-coated thermal papers in resisting humidity, they still have limitations. One major drawback is the increased cost, which makes them less attractive for applications where cost is a significant factor. Additionally, the topcoat can sometimes interfere with the thermal image reaction, reducing print quality. Furthermore, top-coated papers are less environmentally friendly than non-top-coated papers, as the additional coating layer can contribute to waste and pollution. Therefore, and as stated before, there is a need for a more cost-effective and environmentally friendly solution to improve the humidity resistance of NTC thermal papers.

A novel barrier coating is initially formulated to coat NTC thermal paper or a NTC thermal paper substrate. The barrier coating is applied atop the thermal-sensitive coating, and the thermal-sensitive coating is applied atop at least one side of the paper. In an embodiment, the NTC thermal paper includes a phenol-free direct thermal paper. The barrier coating comprises a polymer composition designed to protect the thermal-sensitive coating (e.g., thermal layer) from humidity contact, thereby maintaining maximum image density for the thermal layer in severe high heat and humidity environments. The barrier coating provides a consistent film-forming layer on the top of the thermal layer.

The barrier coating's polymer composition is specifically chosen to exhibit thermally-activated melting characteristics when a thermal print head engages the barrier coating during a thermal imaging print job of a thermal printer. This ensures the coating does not interfere with the thermal image reaction of the thermal layer during the print job, thereby preserving the print or image quality while maintaining thermal reactivity of the underlying thermal-sensitive coating.

NTC papers can be used in an embodiment by applying the barrier coating on NTC phenol-free direct thermal paper, which is more environmentally friendly than top-coated papers. As a result, waste is reduced and environmental sustainability is achieved.

The barrier coating technology extends the usable temperature range of NTC thermal papers. While conventional NTC papers typically perform optimally between 15-25° C., barrier-coated papers maintain consistent performance across a broader range of −10° C. to 60° C. This expanded operating range makes the treated papers suitable for automotive, marine, and industrial applications where temperature fluctuations are common. The polymer composition remains stable across this extended temperature range while maintaining its thermally-activated melting characteristics.

In an embodiment, the barrier coating on the NTC surface of the thermal layer for the paper enhances the paper's moisture and humidity resistance. This prevents a decrease in image density and quality on the paper in severe high-heat and humidity environments during printer imaging, improving printed images'overall performance and longevity following printer imaging. The barrier coating melts when contacting the thermal print head, does not block the thermal image reaction of the thermal layer during imaging/printing, provides a consistent film that forms on the thermal layer to protect from heat and moisture conditions, and ensures high-quality prints/images on the paper. The polymer composition maintains thermal reactivity of the thermal-sensitive coating while providing enhanced humidity protection. Performance testing has demonstrated that thermal papers treated with the barrier coating maintain image density retention of greater than 85% after exposure to 40° C. and 75% relative humidity for 168 hours, compared to untreated papers which show density retention of less than 60% under identical conditions.

In an embodiment, a barrier coating formulation is prepared using the following ingredients: 40-60% (preferably 50%) hard film forming acrylic emulsion (Acid number (NV): 40-80, preferably 50-70, molecular weight (Mw): >150,000, preferably >200,000, glass transition temperature (Tg): 10-30° C., preferably 15-25° C., minimum film formation temperature (MFFT): 5-20° C., preferably 10-15° C.); and 40-60% (preferably 50%) soft film forming acrylic emulsion (Acid number (NV): 40-80, preferably 50-70, Mw: >150,000, preferably >200,000, Tg: −40 to −10 ° C., preferably −20 to −30 ° C., MFFT: <10° C., preferably <5° C.). The ingredients are mixed to form a coating solution. The concentration of the coating solution is adjusted to achieve a viscosity of 300-2,000 centipoise (cps), preferably 500-1,000 cps. The barrier coating formulation may include additives from the group consisting of surfactants, defoamers, rheology modifiers, crosslinking agents, and combinations thereof. Next, the barrier coating formulation is applied to the NTC surface of phenol-free direct thermal paper using a coating machine such as a slot-die coater, a gravure coater, a blade coater, a curtain coater, or a flexographic coater. The coating is applied to a coat weight of 0.5-15 grams per square meter (gsm), preferably 3-5 gsm or 1-10 gsm in a dry state (1-30 gsm, preferably 6-10 gsm or 2-20 gsm in a wet state). The barrier-coated paper is then dried at 40 to 120° C., preferably 60-80° C. or 50-100° C. for 1-30 minutes, preferably 5-10 minutes. This ensures the water evaporates, and the barrier coating is firmly attached to the paper surface.

The manufacturing process for applying the barrier coating is compatible with existing paper coating equipment and can be integrated into current thermal paper production lines with minimal modifications. The coating solution exhibits excellent stability with a shelf life of 6-12 months when stored under appropriate conditions. Quality control parameters include viscosity monitoring, pH measurement (typically 7-9), and solids content verification.

Alternative embodiments include applying the barrier coating in multiple thin layers rather than a single thick layer, which can improve uniformity and reduce coating defects. Multi-layer application involves applying 2-4 successive coats, each at 1-3 gsm dry weight, with intermediate drying between applications. The coating can be applied using various methods including slot-die coating, gravure coating, blade coating, curtain coating, kiss coating, and spray coating.

The polymer used in the barrier coating is specifically chosen to melt in the print head during printing, ensuring that the coating does not interfere with the thermal image reaction. This technique provides a practical and cost-efficient way to improve the humidity resistance of NTC phenol-free direct thermal paper. The barrier coating not only enhances the moisture and humidity resistance of the paper but also maintains maximum image density in severe high-heat and humidity environments. Furthermore, environmentally friendly non-top-coated paper and the cost-effective barrier coating make this technique attractive for a wide range of applications.

The proposed embodiments are more environmentally friendly than existing top-coated papers. The additional layer of coating in top-coated papers can contribute to waste and pollution. In contrast, the barrier coating on non-top-coated paper does not add an extra layer that could potentially harm the environment. The use of this barrier coating on non-top-coated papers provides a more cost-effective solution for improving humidity resistance compared to using top-coated thermal papers, making it an attractive option for applications where cost is a significant factor.

The barrier-coated thermal paper can be manufactured as individual labels or as a continuous web of thermal paper that can be wound into a roll to form a roll of labels. When configured as a roll of labels, the thermal paper maintains its barrier coating properties throughout the winding process, ensuring consistent performance across the entire roll length.

In embodiments configured for labeling applications, the thermal paper substrate may further include adhesive backing applied to the side opposite the thermal-sensitive coating and barrier coating. The adhesive backing enables the thermal paper to function as self-adhesive labels suitable for various label applications, including product labeling, shipping labels, and identification tags.

The barrier coating for NTC thermal paper offers several key advantages over existing solutions. It provides superior humidity resistance while maintaining cost-effectiveness and environmental sustainability. The barrier coating enables improved image quality retention in high heat and humidity compared to both uncoated and top-coated papers.

Performance testing has demonstrated that thermal papers treated with the barrier coating maintain image density retention of greater than 85% after exposure to 40° C. and 75% relative humidity for 168 hours, compared to untreated papers which show density retention of less than 60% under identical conditions. The barrier coating provides particular advantages in tropical climates and refrigerated storage applications where condensation is prevalent. This enhanced performance allows the barrier-coated NTC thermal paper to maintain maximum image density in severe high heat and humidity environments, outperforming uncoated papers which showed a decrease in image density and quality under similar conditions. The barrier-coated paper also demonstrated comparable or better performance to top-coated papers in terms of humidity resistance, while offering additional benefits such as lower cost and reduced environmental impact. Specifically, the barrier coating enables improved image quality retention in high heat and humidity compared to both uncoated and top-coated papers.

The environmental benefits of this barrier coating extend beyond waste reduction. The manufacturing process consumes less energy compared to top-coated papers, contributing to a reduced carbon footprint. Additionally, using NTC papers reduces the overall amount of coating materials, minimizing environmental impact. This barrier-coated thermal paper's improved humidity resistance and image quality retention enable its use in novel applications. These include outdoor signage, where exposure to varying weather conditions is common, and cold-chain logistics labeling, where resistance to condensation and temperature fluctuations is crucial. Other potential applications include marine labeling, where high humidity is a constant challenge, and industrial labeling in high-temperature environments. This versatility expands the potential market for thermal paper products while maintaining eco-friendly characteristics.

The application prospects of the embodiments presented herein are promising, particularly in industries where thermal printing is extensively used, such as labeling, ticketing, and receipt printing. With the increasing awareness about the environmental impact of printing, there is a shift towards more sustainable printing practices. The embodiments, with their ability to improve the humidity resistance of non-top-coated thermal papers without compromising on print quality or cost-effectiveness, meets this market demand for high-quality, cost-effective, and environmentally friendly printing solutions. In terms of market demand, there is a growing need for high-quality, cost-effective, and environmentally friendly printing solutions.

Technical terms used herein are defined as follows: Acid number (NV) refers to the mass of potassium hydroxide (KOH) in milligrams required to neutralize one gram of the polymer solids; Mw denotes weight average molecular weight; Tg represents glass transition temperature; and MFFT stands for minimum film formation temperature.

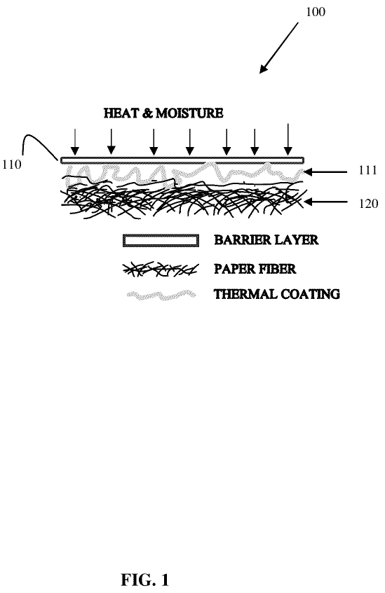

FIG. 1 is a diagram 100 of a barrier coating 110 applied to a non-top-coated (NTC) thermal paper, according to an example embodiment. Notably, diagram 100 is shown in simplified form, as more or fewer components may be present without departing from the teachings presented herein.

The barrier coating exhibits superior adhesion properties to the thermal layer, with peel strength values ranging from 2-8 N/25 mm when measured according to standard adhesion testing protocols. This strong adhesion ensures the coating remains intact during handling and processing while allowing thermal activation during printing. The barrier coating formulation can be customized for specific end-use applications by adjusting the ratio of hard to soft film-forming emulsions. For high-temperature applications, the hard emulsion content can be increased to 70-80%, while for low-temperature flexibility, the soft emulsion content can be increased to 60-70%.

Paper fibers 120 of an NTC thermal paper are coated with a thermal-sensitive coating 111. The barrier coating 110, discussed above, is then coated atop the thermal-sensitive coating providing a heat and moisture-resistant film that protects the thermal paper and the thermal-sensitive coating 111.

The barrier coating 110 comprises a polymer composition that exhibits thermally-activated melting characteristics that cause the barrier coating 110 to melt when in contact with a thermal print head of a thermal printer. The barrier coating 110 also exhibits a second characteristic when melted to form a uniform protective film over the thermal layer or thermal-sensitive coating 111, which enhances print or image quality when a print job images custom indicia onto the paper fibers 120 via selective activation of heat onto the thermal-sensitive coating 111.

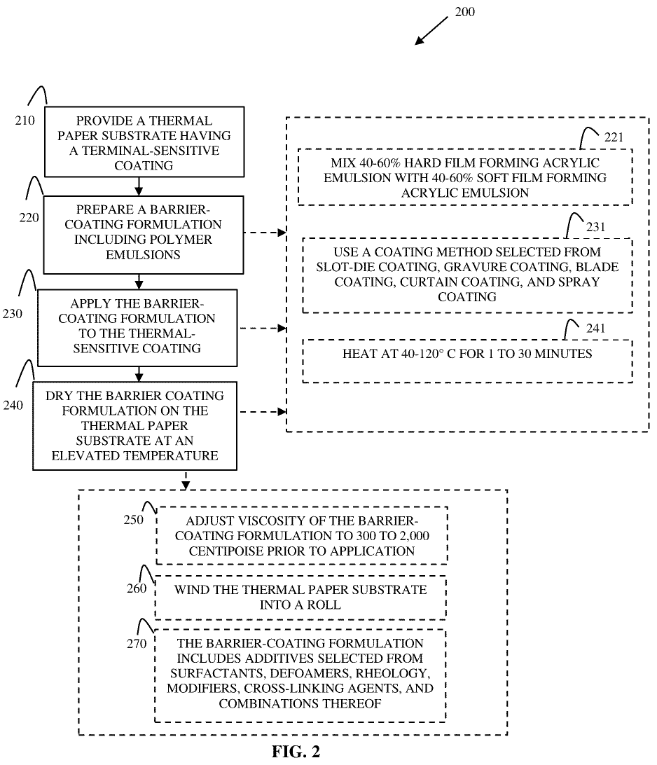

FIG. 2 is a diagram of a method 200 for making and applying the barrier coating to an NTC thermal paper, according to an example embodiment. In an embodiment, electromechanical components of press stations are controlled via firmware or software to perform the method 200.

At 210, the press is provided a thermal paper substrate having a thermal sensitive coating. At 220, the press is provided or prepares a barrier-coating formulation, including polymer emulsions. In an embodiment, at 221, the press is provided or prepares a mix of 40-60% hard film forming acrylic emulsion with 40-60% soft film forming acrylic emulsion.

At 230, the press applies the barrier-coating formulation to the thermal-sensitive coating. In an embodiment, at 231, the press uses a coating method selected from slot-die coating, gravure coating, blade coating, curtain coating, and spray coating.

At 240, the press dries the barrier-coating formulation on the thermal paper substrate at an elevated temperature. In an embodiment, at 241, the press applies heat to the barrier-coating formulation on the thermal paper substrate at 40 to 120° C. for 1 to 30 minutes.

In an embodiment, at 250, the press adjusts viscosity of the barrier-coating formulation to 300 to 2,000 centipoise prior to application. In an embodiment, at 260, the press winds the thermal paper substrate into a roll. In an embodiment, at 270, the barrier-coating formulation includes additives selected from surfactants, defoamers, rheology modifiers, cross-linking agents, and combinations thereof.

Although the present invention is described with reference to certain preferred embodiments, variations and modifications of the present invention can be made within the spirit and scope of the following claims.

1. A label, comprising:
a non-top-coated thermal paper substrate having a thermal-sensitive coating; and
a barrier coating applied over the thermal-sensitive coating;
wherein the barrier coating comprises a polymer composition that exhibits thermally-activated melting characteristics when contacted by a thermal print head.

2. The label of claim 1, wherein the polymer composition comprises an acrylic emulsion.

3. The label of claim 2, wherein the acrylic emulsion comprises a hard film forming acrylic emulsion and a soft film forming acrylic emulsion.

4. The label of claim 3, wherein the hard film forming acrylic emulsion comprises 40-60% by weight of the barrier coating.

5. The label of claim 1, wherein the barrier coating is applied at a coat weight of 0.5-15 grams per square meter in dry form.

6. The label of claim 1, wherein the barrier coating provides humidity resistance while maintaining thermal reactivity of the thermal-sensitive coating.

7. The label of claim 1, wherein the non-top-coated thermal paper substrate comprises a phenol-free direct thermal paper.

8. A roll of labels, comprising:
a continuous web of thermal paper wound into a roll, the thermal paper comprising:
a substrate having a thermal-sensitive layer; and
a barrier coating applied to protect the thermal-sensitive layer from environmental conditions;
wherein the barrier coating is formulated to melt upon thermal activation while providing moisture protection.

9. The roll of labels of claim 8, wherein the barrier coating comprises 40-60% hard film forming acrylic emulsion and 40-60% soft film forming acrylic emulsion.

10. The roll of labels of claim 8, wherein the barrier coating has a viscosity of 300-2,000 centipoise.

11. The roll of labels of claim 8, wherein the barrier coating provides image density retention of greater than 85% after humidity exposure testing.

12. The roll of labels of claim 8, wherein the substrate is phenol-free.

13. The roll of labels of claim 8, further comprising adhesive backing to enable label applications.

14. A method comprising:
providing a thermal paper substrate having a thermal-sensitive coating;
preparing a barrier coating formulation comprising polymer emulsions;
applying the barrier coating formulation to the thermal-sensitive coating; and
drying the barrier coating formulation on the thermal paper substrate at an elevated temperature.

15. The method of claim 14, wherein preparing the barrier coating formulation comprises mixing 40-60% hard film forming acrylic emulsion with 40-60% soft film forming acrylic emulsion.

16. The method of claim 14, wherein applying the barrier coating formulation comprises using a coating method selected from slot-die coating, gravure coating, blade coating, curtain coating, and spray coating.

17. The method of claim 14, wherein drying comprises heating at 40 to 120° C. for 1 to 30 minutes.

18. The method of claim 14, further comprising adjusting viscosity of the barrier coating formulation to 300 to 2,000 centipoise prior to application.

19. The method of claim 14, further comprising winding the thermal paper substrate into a roll.

20. The method of claim 14, wherein the barrier coating formulation further comprises additives selected from surfactants, defoamers, rheology modifiers, crosslinking agents, and combinations thereof.
